(19) United States
(12) Patent Application Publication
(10) Pub. No.: US 2007/0248077 A1
(43) Pub. Date: Oct. 25, 2007

(54) Distributed voice over internet protocol apparatus and systems

(75) Inventors: Carl J. Mahle JR., Davie, FL (US); Marwan Ammoun, Dubai (AE)

Correspondence Address: Kirkpatrick & Lockhart Preston Gates Ellis LLP;(FORMERLY KIRKPATRICK & LOCKHART NICHOLSON GRAHAM), STATE STREET FINANCIAL CENTER, One Lincoln Street, BOSTON, MA, 02111-2950, US

(73) Assignee: Fusion Telecommunications International, Inc., New York, NY (US)

(21) Appl. No.: 11/407,580

(22) Filed: Apr. 20, 2006

(51) Int. Cl. H04L 12/66; H04L 12/56

(52) U.S. Cl. 370/352; 370/401

(57) ABSTRACT

In one embodiment, the invention relates to a telephony system. In one embodiment of the invention, the system includes a first communication device adapted to interface with a client application, a second communication device, the second communication device adapted to exchange voice over internet protocol (VoIP) data with the first communication device, and a server comprising a route engine, wherein the route engine is adapted to exchange provisioning data with the client application such that VoIP packet data remains channeled through a public network such that it is separated from the server.

### FIELD OF THE INVENTION

An embodiment of the invention relates to apparatus and systems for routing voice over IP (VoIP) communications and, more specifically, to apparatus and systems for routing VoIP communications using a route engine to initiate communication channels to achieve enhanced scalability and security in a carrier-class VoIP environment.

### BACKGROUND OF THE INVENTION

As VoIP technology is poised to overtake traditional carrier services as the primary voice communication method, there are increased demands on the quality, speed and scalability of the technology itself. Traditional client-server VoIP telephony environments require substantial hardware infrastructure. As a result, such systems do not scale cost effectively. Some implementations of VoIP technology use a carrier server that functions analogously to traditional phone service carrier hardware in the sense that the server actually channels the VoIP traffic and underlying data packets. This approach raises a host of scalability problems. Thus, if there is a large directory environment with a large number of users, many servers are required to handle the communications between the users. Thus, the cost of the server infrastructure becomes significant. In addition, the data load imposed on the servers can result in communication problems between end users.

Some of the existing P2P VoIP communications approaches represent a step forward from a pure client-server architecture. Current implementations of P2P telephony may use either a proprietary protocol or a version of Session Initiated Protocol incorporating Dynamic Hash Table structures. Both implementations require the use of an intermediary server, referred to as a “super node”, to function. In some of the currently deployed telephony systems, super nodes are elected from within the peer user communities. This election of super nodes often occurs without the explicit knowledge of the computer owner. This has substantial security disadvantages including potentially compromising the super node machines for use in Denial of Service (DOS) attacks.

Additionally, in other P2P telephony environments specialized hardware components are required for the end users to make calls. Therefore, in order to operate, all of the provisioning and call traffic resides in the end user (“peer”) hardware environment. Accordingly, in such a system specialized VoIP phones are required by all end users. For a P2P telephone instrument to function properly, it must contain sufficient memory and processing ability to handle the “presence” or on-line state for every other user with which it may wish to communicate. As the number of users on P2P systems grows beyond a few users, this type of system becomes problematic. Additionally, requiring all users to have proprietary VoIP hardware will be costly and may preclude market acceptance.

Current P2P telephony systems, either those reliant on super nodes or end user hardware, may be suited for a closed network environment such as an enterprise business. However, in an open worldwide carrier environment, these approaches remain impractical.

Therefore, a need exists for VoIP implementations that address the deficiencies associated with the systems identified above.

### SUMMARY OF THE INVENTION

Embodiments of the invention provide the benefits of a client-server structure, but at dramatically reduced costs of infrastructure. As such, the apparatus, systems and methods disclosed herein facilitate VoIP telephony that offers increased economies of scale, improved security, and frees end users from using proprietary hardware. To the extent that a client-server relationship is used to implement an embodiment of the invention, the relationship is short lived, and a non-carrier server is used such that the relationship is initiated to connect two end users and not maintain the VoIP data channel between them. As a result, the servers described herein that run various modules and engines are not burdened by the high bandwidth demands associated with VoIP traffic typically in a carrier server implementation. Therefore, the embodiments of the invention disclosed herein, do not require super nodes or DHT functionality.

The VoIP telephony systems disclosed herein with respect to the various embodiments of the invention can accommodate over an estimated two million active users when carried by a pair of low cost single processor computers. More robust computing platforms, such as dual core processors and multi-processor server blades will enable greater communication channel initiation capacities. Additionally, the Routing Engine (RE) used to initiate communication channels between users, discussed in more detail below, will accommodate at least 8,000 route requests per second. These performance levels allow the telephony system embodiments disclosed herein to grow to support millions of users in an economical approach that has remained unattainable to date. Additionally, because various system embodiments do not rely on the use of unsupervised servers, such as the “super nodes” used in other peer-to-peer deployments, the network security vulnerability is substantially reduced.

For traditional peer-to-peer services to function, a look up table of all potential connections between end users must be stored on each end user device. This presents scaling challenges, as larger and larger storage components are required for larger numbers of potential users. The embodiments of the invention facilitate contact between users and monitor their status within the system without requiring storage capacity upgrades at each end user communication device as the number of users increases.

The features of various embodiments of the invention offer cost savings to consumers when compared to existing carrier services and offers dramatically reduced infrastructure costs to service providers. To that end, embodiments of the invention incorporate the ability to provide high quality telephone calls, substantially continuous monitoring and management, and when appropriate, accurate and timely records for use in rating calls and rendering of bills.

Prior to discussing some of the VoIP telephony embodiments of the invention in detail, an introduction to some of the characteristic terminology used with respect to route engines and other components of the telephony systems disclosed herein may prove informative. However, the scope of the terms discussed herein is not intended to be limiting, but rather to clarify their usage and incorporate the broadest meaning of the terms as known to those of ordinary skill in the art.

Associations can include, but are not limited to lists of devices and their calling relationships. Associations can be used to partition VoIP network devices such that one group of devices cannot call another group.

Customers can include, but are not limited to end users or traffic exchange partners. Customers may be identified with gatekeepers, endpoints, hunt groups, or Automatic Number Identifications (ANIs). Customers may have routes for their exclusive usage thus providing special routing capabilities.

Gatekeepers are capable of at least one of managing on-net endpoint registration, validating admission for call placement and handling call location requests from off-net gatekeepers. Gatekeepers may have routes associated with them and can be configured to be on or off net. Gatekeepers can be members of associations and can be linked to a customer.

Endpoints can include, but are not limited to gateways or terminals (clients). Endpoints devices/clients can register with gatekeepers to place calls. An endpoint can have attributed routes, be a member of an association and be linked to a customer.

Alternate Gatekeepers Lists may be provided to endpoints to help them recover from network or gatekeeper device failures. After losing a current registration connection with a gatekeeper, the endpoint may try to re-register within the on-net network using the listed gatekeepers.

Hunt groups can be used to represent all or a portion of a gateway endpoint based on the configured communication channels. Hunt groups may have attributed routes, be a member of an association and be linked to a customer.

Route Lists can include, but are not limited to dialed numbers that can have calls completed to devices linked to these routes. Route Lists may be linked to gatekeepers, endpoints, hunt groups and may be customer specific.

It should be understood that the order of the steps of the methods of the embodiments of the invention is immaterial so long as the embodiments of the invention remain operable. Moreover, two or more steps may be conducted simultaneously or in a different order than recited herein unless otherwise specified.

It should be understood that the terms “a,” “an,” and “the” mean “one or more,” unless expressly specified otherwise.

The foregoing, and other features and advantages of embodiments of the invention, as well as the invention embodiments, will be more fully understood from the description, drawings, and claims which follow.

### BRIEF DESCRIPTION OF THE DRAWINGS

These embodiments of this invention will be readily apparent from the detailed description below and the appended drawings, which are meant to illustrate and not to limit the invention, and in which:

FIG. 1 is a block diagram illustrating an overview of a distributed VoIP telephony system according to an embodiment of the invention;

FIG. 2 is a block diagram illustrating the components of a distributed VoIP telephony system according to an embodiment of the invention;

FIG. 3A is a block diagram illustrating a system for routing VoIP traffic in a Session Initiated Protocol network according to an embodiment of the invention;

FIG. 3B is a block diagram illustrating a system for routing VoIP traffic in a H.323 network according to an embodiment of the invention; and

FIG. 4 is a block diagram of the Route Manager used in a VoIP system according to an embodiment of the invention.

### DETAILED DESCRIPTION

Embodiments of the present invention will be more completely understood through the following detailed description, which should be read in conjunction with the attached drawings. In this description, like numbers refer to similar elements within various embodiments of the invention. Within this detailed description, the claimed invention will be explained with respect to embodiments. However, the skilled artisan will readily appreciate that the embodiments described herein are merely exemplary and that variations can be made without departing from the spirit and scope of the embodiments of the invention.

The embodiments of the invention disclosed herein relate to VoIP telephony systems and the associated components that are designed to improve the cost of investment, scalability, and security of a telephony system. Typically, the engines, modules, managers, systems and other embodiments of the invention are installed on or are associated with an end user communication device, a VoIP phone, a cellular telephone, a computer server, an ASIC, a client application, or other suitable electronic data processing apparatus.

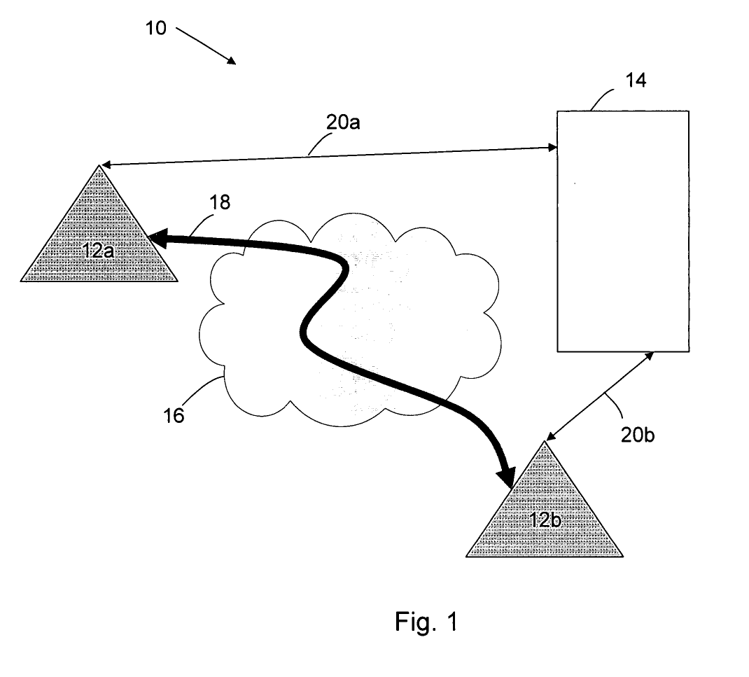

FIG. 1 is a high level block diagram illustrating a distributed VoIP system 10 according to an embodiment of the invention. The telephony system 10 is distributed such that data between a plurality of system end users are not transmitted through a centralized carrier device or carrier server. Instead, communication channels are initiated between end users of the system 10 to conduct VoIP data packets using a public network such as a portion of the public internet. As a result, the plurality of communications channels that the system 10 initiates over time do not require a carrier server or super node.

The embodiments of the invention disclosed herein are suitable for transmitting various types of data through a communication channel. Any suitable data type that can be routed through the internet can be transmitted via the techniques and devices disclosed herein. In particular, the embodiments disclosed herein can be used to transmit voice communications, video data, audio data, text messages, images, and other suitable data of interest to consumers and industry. The data transmitted using a communication channel can be sent in real-time or as a downloaded file available for access at a later time. This approach is useful when transmitting video between two or more users. In some embodiments, various audio and video codecs are implemented to facilitate data processing.

In this embodiment, the system 10 is designed to eliminate the need for any super node and built with a directed environment which includes a non-carrier server 14 in communication with two end users 12a, 12b. The server 14 is adapted to form communication channels between the end users. The server 14 is operated independently of each end user 12a, 12b. The server 14 is adapted to permit any combination of on-net and off-net calling patterns as a result of the route engine it incorporates. In addition, gatekeepers, endpoints, and hunt groups may be managed by the route engine based on the current call count or bandwidth load. The end users 12a, 12b communicate with the server 14 via a network. The network may be a portion of the public internet 16, as in this embodiment, or other types of wide-area networks (WANs) or local-area networks (LANs) in various embodiments.

Although the illustration only depicts two end users, the server can handle a large number of end users at the same time. This follows in part because the server is connecting the two end users and then ceasing to be involved in the VoIP data packet exchange. As a result, the bandwidth associated with the actually voice traffic is channeled through the internet or another network and not the server 14. Therefore, the server can be implemented using a low cost computer such as the consumer processors produced by IBM, Intel, and AMD, as well as other suitable inexpensive forthcoming processors and existing legacy processors.

In order to establish a VoIP connection between the end users 12a, 12b, a software client is downloaded and installed on the communication devices used by the end users 12a, 12b. The client application may be downloaded from the server 14 or a different source such as a website. The communication devices may include, but are not limited to a software phone, a broadband IP phone, a PDA, a cellular telephone, a pager, or a personal computer that has VoIP capability.

To initiate a VoIP communication route or channel 18, the first end user 12a contacts the server 14 using a client application (not shown) and makes a request to locate the second end user 12b. The data exchange between the first end user 12a and the server 14 is shown by data channel 20a. The server 14 then checks a number of databases (not shown) that contain provisioning and address information with regard to end users and determines whether or not the second end user 12b is available to talk. Data channel 20b represent the flow of information to the server 14 that indicates the second end user 12b is available to receive a call. As shown, data channels 20a, 20b and VoIP communication route/channel 18 are separate channels. In some embodiments, all three channels pass through the internet 16. However, the data channels are never used to carrier voice communications through the server 14. That is, the server is configured such that packet data transmitted through the VoIP communication channel is isolated from the server 14.

If the second user 12b is successfully located, the server proceeds to connect the first end user 12a and the second end user 12b by establishing a VoIP communication route 18 over the internet 16. In one embodiment, once the route 18 is established, the server 14 disconnects from end users 12a, 12b and ceases to interact with the end users. In another embodiment, the server 14 remains uninvolved with the voice communication channel, but monitors whether the end users remain on line and/or if the call conducted over the VoIP channel has terminated.

Since the VoIP communication route between the end users 12a, 12b is initiated such that the route the data traverses uses portions of the internet in lieu of the server, the server benefits from this bandwidth partitioning. Thus, the overall telephony system functions as a distributed user system with directed server connections that does not use intermediary carrier servers or super nodes. The server 14, as illustrated in this embodiment, is only used in the initial step of connecting the end users 12a, 12b, but not in the maintaining the communication route 18 as required in the traditional VoIP systems.

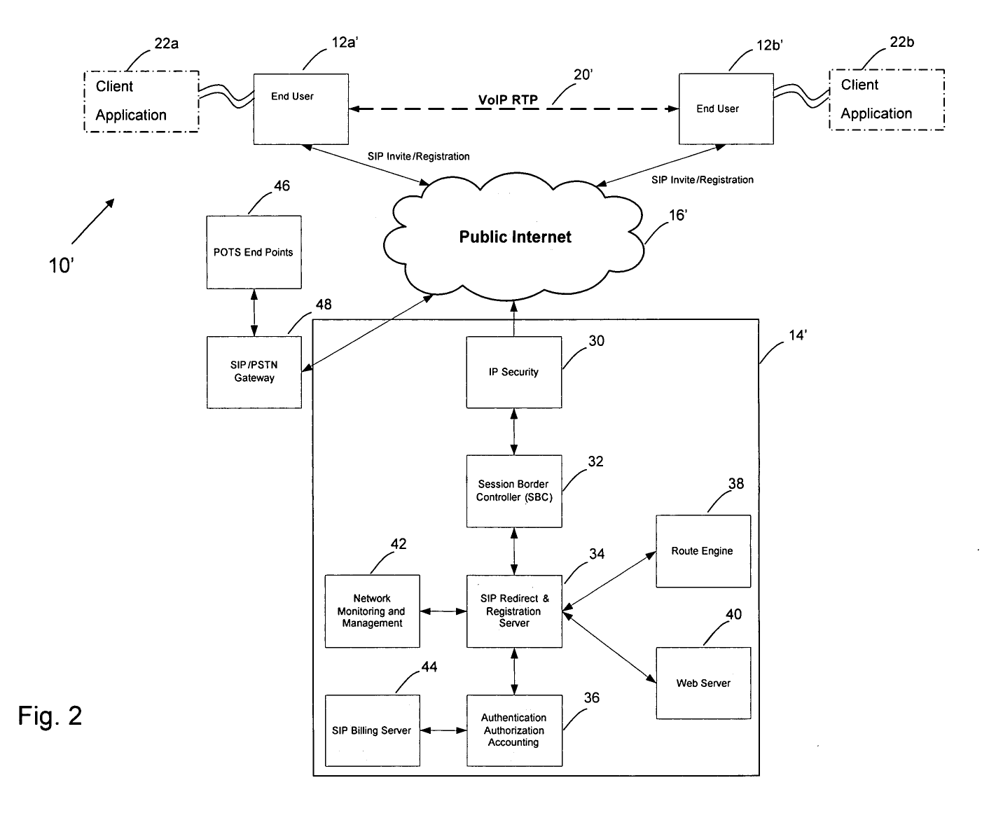

FIG. 2 is a detailed block diagram illustrating a system 10′ and the components associated with the placement of a call using Directed SIP P2P Telephony (DSP) technology according to another embodiment of the invention. Similar to the embodiment illustrated by FIG. 1, the system embodiment 10′ shown in FIG. 2 also enables two end users 12a′, 12b′ to establish a voice communication route 20′ via a non-carrier server 14′ and the internet 16. FIG. 2 further illustrates the various components of the server 14′ used in the process of connecting the two end users 12a′, 12b′.

As discussed above, the end user's communication devices are associated with a client application 22a, 22b such as user agent. For example, a computer that is used to place VoIP calls using an internet connection and microphone/earphones would typically have a client application installed within the operating system. These client applications can be made available by download, mass mailing, OEM partnering, and other delivery mechanisms. The client application can include, but is not limited to the following components: a SIP stack, audio codecs, a provisioning interface (utilizing HTML and SOAP in one embodiment), functional features (such as a phonebook and a call history log), diagnostic tools for testing and troubleshooting, a STUN (Simple Traversal of User Datagram Protocol over Network Address Translation) client for analyzing a user's NAT and firewall configurations, and a port ping module to allow for analysis of port availability on firewalls. The client application operates by the user downloading it from a web site, activating the program, following the instructions, and then using it in a passive or active manner for the ability to accept or place voice telephone calls. Typically, the client application and the server components, such as the route engine can be implemented using one of C, C++, SOAP, XML, Java, and other programming languages as appropriate. Specific address information relating to how to securely connect to the server is integrated within the server 14′.

As shown in FIG. 2, the server 14′ can include at least one of an IP security component 30, a session border controller (SBC) 32, a SIP Redirect & Registration Server (registration module) 34, an Authentication Authorization Accounting Server (AAA) 36, a route engine 38, a web server 40, a network monitoring and management component 42, and a SIP Billing Server 44. The server 14′ and the end users 12a′, 12b′ are connected to the public internet 16. In some embodiments, the AAA server, the SIP Billing server, the SIP Redirect & Registration Server, and the web server are separate elements from the overall non-carrier telephony system server 14′. However, in other embodiments, these other servers are modules integrated either altogether or in part within the system server 14′.

According to this embodiment, to place a call using the Directed SIP P2P (DSP) telephony technology between the two end users 12a′, 12b′, each end user 12a′, 12b′ first accesses the web site hosted on the web server 40 to create a personal account and register. Registration occurs in the Registration Database (not illustrated) and each end user 12a′, 12b′ is issued a software client application such as a user agent that is associated with the VoIP telephony system 10′. In variations of this embodiment, the step of obtaining the software client may be optional. The end users 12a′, 12b′ may use any compatible communication devices, such as SIP IP Phones (software or hardware-based) in place of the software client as the user agent. The client application/user agent (device, soft phone, IP phone, software client installed on PCs, etc.) is registered using SIP when activated. Once registered, end users 12a′, 12b′ can be authenticated and authorized by the AAA server 36 each time they request a connection from the system 10′.

To initiate a voice telephone call, the first end user 12a′ sends a SIP Invite through the internet 16 to the server 14′. The SIP Invite is processed by the SIP Redirect and Registration Server 34 and passed to the route engine 38 to identify the destination IP address for the called party, the second end user 12b′. Once the validity of the second end user 12b′ is determined, the SIP Redirect and Registration Server returns a confirmation message to the first end user 12a′. This confirmation message contains the second end user's 12b′ IP address. The first end user 12a′ then sends a SIP Invite directly to the second end user's 12b′ IP address and proceeds to setup a SIP P2P call.

Once a connection is established between the end users 12a′, 12b′ via the IP address, ringing is initiated on the second end user's 12b′ user agent. Upon the second end user's 12b′ answering the call, a VoIP RealTime Transport Protocol (RTP) stream is established to maintain the VoIP communication channel 20′ for the duration of the call in a distributed fashion with no further interface with the server 14′. However, other protocols other than RTP can be used as known in the art to form the channel 20′. When the call ends, a disconnecting signal is sent and acknowledged by the user agents on both ends, thus closing the stream 20′ between the end users 12a′, 12b′.

According to a variation of the embodiment, the end user 12a′ can also make “off-net” calls to destinations other than subscribers of the VoIP service, such as users of analog telephones or other devices. Similarly, the first end user 12a′ first needs to access the web site hosted on the web server 40 to create an account and register. Registration occurs in the Registration Database (not shown) and the end user 12a′ may be issued software client as the user agent that is associated with the service. As discussed above, the software client is also optional, and the end user 12a′ may use any compatible SIP IP Phone (software or hardware-based) to make calls. The user agent (device, soft phone, IP phone, software client on PCs, etc.) is registered using SIP when activated. In addition, the end user 12a′ may also be required to set up a financial account and have it validated. Then, the end user 12a′ is authenticated and authorized by the AAA server 36, and a determination occurs regarding the balance available in the financial account or credit terms.

After the account status is verified by the authentication procedure, a SIP Invite is sent to the server 14′. The additional step of having the SIP Billing Server 44 performing account balance verification after receiving SIP Invite is required for an “off-net” call. If account status is not acceptable as determined by the billing server 44, a recorded voice message provides additional information to the first end user 12a′. If accepted, SIP Redirect and Registration Server 34 returns a confirmation message to the end user 12a′ (intercepted and handled by the session border controller (SBC)). In one embodiment, the SBC serves three purposes. The first purpose of the SBC is its role as an address source for other communication devices, this follows because the SBC's public IP address is the only address foreign gateways and gatekeepers need to know about. This SBC feature increases network security by effectively hiding the internal network structure and addressing scheme. The second purpose of the SBC is to minimize interoperability issues by mediating H.323 and SIP signaling between local and foreign gateways and gatekeepers. The third purpose of the SBC is to facilitate the passage of media through the SBC to overcome some of the issues created by NAT (network address translation) and firewall traversals. This message contains the destination IP address of the end user at the Plain Old Telephone Service (POTS) end point 46.

To proceed with the call, the first end user 12a′ sends a SIP Invite to the SIP Billing Server 44. The SIP invite is processed by the SIP Redirect and Registration Server 34 and transmitted to the route engine 38 to identify the destination IP address for the called party, the end user at the POTS end point 46. During this process, the validity of the desired destination and the associated pricing is determined. The IP to PSTN gateway performs voice compression on the IP side of the call using voice compression/decompression - codecs (vocoders) such as G.729 and G.723. The gateway also performs protocol translations between the PSTN and IP networks (pulse code modulation to real-time protocol). This permits the interchange of voice communications between the traditional PSTN environment and the Internet.

After all the information is verified and approved, ringing is initiated at the POTS End Point 46. Upon the end user at the POTS End Point 46 answering the call, a VoIP data channel is established for the duration of the call in a P2P fashion such that server 14′ is not responsible for the VoIP data channel and the security of the call is not compromised by voice data packets passing through the server 14′. When the call ends, a disconnect signal is issued and acknowledged at both ends 12a′ 46. For such “off-net” calls, duration of each call is calculated and the end user's 12a′ financial account is debited the appropriate amount for the call.

The aforementioned embodiments, as illustrated by FIG. 1 and 2, teach how a single call between two end users may be routed over a distributed VoIP telephony system 10, 10′. For any communication systems, including P2P VoIP networks, scalability has always been a key issue because a large number of calls have to be handled at any given moment. To achieve better scalability, the systems disclosed in the embodiments herein build upon existing protocols such as H.323 and SIP rather than relying on closed proprietary protocols. This allows for much greater interoperability with other similarly configured devices or systems. This in turn will lead to a much more robust and integrated network community rather than the proliferation of islands of connectivity.

### Client Library Interfaces

Other embodiments of the invention employ client libraries to facilitate the integration of external applications with the servers incorporated in the telephony systems disclosed herein. Specifically, these client libraries facilitate the transfer of provisioning data and retrieve statistical information from the external applications. Suitable libraries can be used with Windows, Linux, Solaris and other OS platforms. Each library can include a set of Application Programming Interfaces (APIs) that can be used to interact with the route manager (XRM) or route engine (XRE) and build real-time applications that use the XRE for routing services or bulk loading the XRM with provisioning data.

For example, an embodiment of the route manager client library includes an API for a plurality of functions. These functions can include route manager login/logout program controls, uploading the current provision data to a route engine, switching route engine provisioning banks, and writing the route engine startup file. Other route manager client library functions include retrieval, creation, updating and deletion of various telephony system parameters that change over time. These parameters include currently provisioned external gatekeeper, internal gatekeeper, external endpoint, internal endpoint, hunt group, customer, alternate gatekeeper list, route list, route, ANI list, ANIs, blocked route, resource control, time of day control, and various associations.

The route engines described herein can use a rule based approach to characterize particular communication channel routes using certain route types and provisioning parameters. These route types and provisioning parameters can include, but are not limited to supported, dedicated, excluded, external access, blocked routes, associations (groups of end-points or affinity groups), exclusive routes (single routes assigned to a specific device as a dedicated route), and combinations thereof. Route engines can be associated with a provisioning bank and can also incorporate a start up file. A provisioning bank refers to the provisioning database used to register and authorize the service for use. In one embodiment, the start up file includes static configuration definitions such as an interface to the soft switch, session border controller, SIP stacks, and application servers. Additionally, the start up file can be configured to define associations and global characteristics of the service specific to each user.

A supported route will route a call to the destination linked with the route. The dialed string of the call typically matches the route range definition. A dedicated route is used when an E.164 number is assigned to an on-net IP device. If the dial string matches a dedicated route, only that route will be used to forward the call to the destination. Alternate routes are typically not used for redundant routes. Excluded routes are used to prevent destinations from being routed to calls with matching dialed strings. Excluded routes override a supported route definition. This permits a clearly defined range of numbers to be removed from a broader supported route definition.

In part, external access is used to describe the role of certain off-net components. Off-net gatekeepers and endpoints may be provisioned to exchange calls with the on-net resources. Off-net devices are identified by IP address providing for a level of security. If a dialed string matches a blocked route, the call will not be routed. Blocked routes may be universal, customer specific, device specific, or association specific.

Provisioning parameters used by the route engines disclosed herein can include, but are not limited to ANI Lists and customer account numbers. Customer account numbers in the form of both ANI and Acct numbers can be used to identify a subscriber and the IP address of that subscriber's device or soft phone.

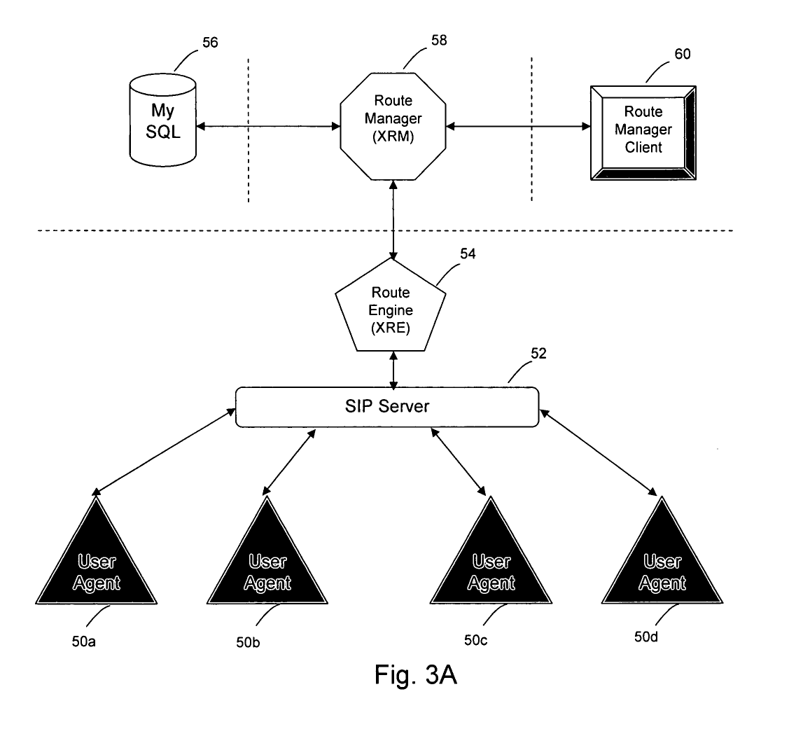

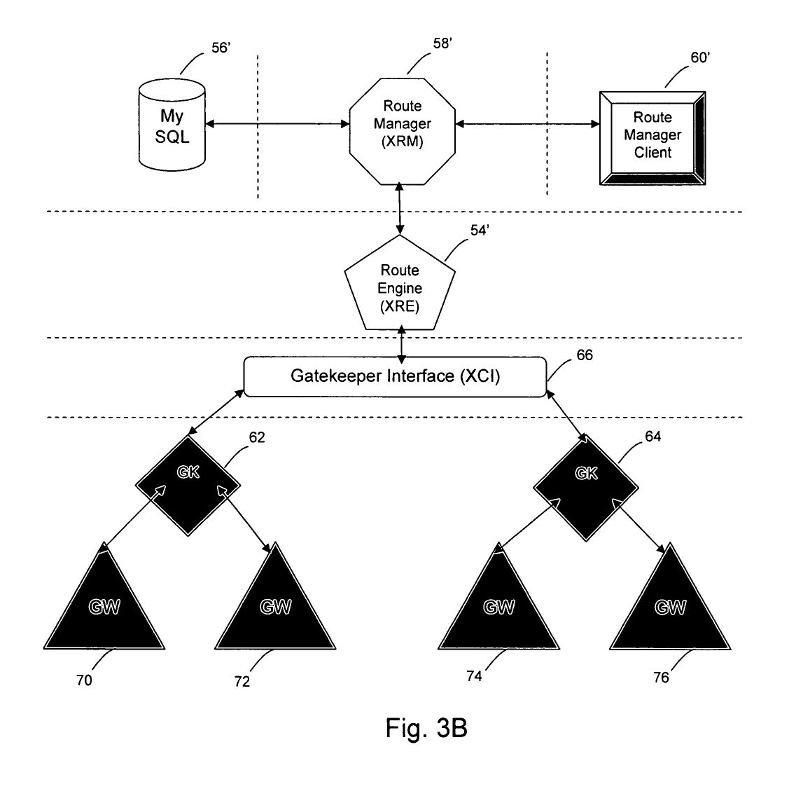

Similarly given the role of the route engine embodiments disclosed herein in establishing connections between end users via user agents and/or client applications, the associated client library focuses on registration and route information. An exemplary route engine library embodiment can provide APIs for the following operations: registering a gatekeeper, un-registering a gatekeeper, registering an endpoint, un-registering an endpoint, requesting destination routes for a dialed number, requesting current route engine performance and combinations thereof. Additional details relating the role of the route engine in a SIP and non-SIP environment are described with respect to FIGS. 3A and 3B.

FIG. 3A is a block diagram illustrating a system for routing VoIP traffic in a SIP network according to another embodiment of the invention. As illustrated, a number of end users (typically user agents associated with a client application affiliated with the distributed VoIP systems described herein) 50a, 50b, 50c, and 50d are simultaneously accessing the VoIP network. As discussed above, these user agents can include, but are not limited to communication devices, soft phone, IP phone, software client installed on PCs, etc. Each of them is connected to the VoIP network via a SIP Server (XSS) 52. The XSS 52 is a SIP compliant server configured to perform at least one of SIP Registrar, SIP Redirect and/or SIP Proxy functions.

As a SIP Registrar Server, the XSS 52 manages registration requests from SIP end users 50a, 50b, 50c, 50d and reports those requests to a route engine (XRE) 54. In turn, the route engine 54 makes routes available and directs the data flows to devices or systems at the associated IP addresses. Registrations are kept alive for the predetermined expiration time during exchange of SIP register messages and responses. An end user 50a, 50b, 50c, 50d will be automatically unregistered in the XRE 54 if a registration status active signal is received during the determined time limit. In variations of this embodiment, secure registration is permitted via the standard SIP specified MD5 algorithm or other algorithms. Passwords used for registration are configured in the route manager (XRM) 54, which will be discussed in detail in the following sections. In general, the route manager is used to implement static configurations and dynamically loads into the route engine.

As a SIP Redirect server, the XSS 52 performs call routing functions only and does not maintain active call records. It responds to Invite messages with a 302 Moved Temporarily message if the Invite can be routed by the XRE 54. As a SIP Proxy server, the XSS 52 performs full call setup management and Call Detail Records (CDRs) reporting. All SIP call setup messages and conditions are handled to support one or more of the following feature set: SIP protocol for all IP devices; IP Phone to IP Phone calling with and without video; IP Phone to PSTN calling; PSTN to IP Phone calling; seven digit local dialing; ten digit local dialing; Caller ID; Call Waiting; and Call Hold. In other variations of the embodiment, additional features such as Directory Listing, voice mail, area code selection, call hunt, call return (*69) (call last number received), international call block, caller ID block (*67), call forwarding, call transfer, call conferencing, video conferencing, may also be supported.

The functions of XSS 52 may be combined to provide for a single server that performs registrations, redirections based on XRE 54 provided instructions, and full call proxy features. For instance, a single server may maintain SIP end user registrations and perform all Invite message processing for the same end user. Based on configuration data provided for each call route request, the XSS 52 may respond to Invites with a “301 Moved Temporarily” message or proxy the call. This permits small networks the convenience to take advantage of all XSS 52 capabilities and allow them to split functions onto individual machine servers when their network traffic grows. This extended capability also permits networks to perform at optimal levels by involving SIP proxy services (not illustrated) when needed, and bypassing them when they are not needed.

The XSS 54 can be configured to write CDRs for each call that it receives for routing. CDRs are produced for all call routing attempts, even those resulting in failure. CDRs may be written to a file or stored in a SQL database via the XDS. When configured for file writing, CDRs can be written to a local file with any suitable name, such as “cdr.cdf” for example. Records in this file can be organized in a comma-delimited format wherein each record is written in an ordered sequence of fields separated by commas and the record is terminated with a new-line character. The maximum size of this file is configurable. When the maximum size is reached, the file is renamed and a new file is created. Proper management of these CDR files is required to prevent system problems and loss of billable information.

Loss of SIP messages and the inability to determine the current call condition via SIP messages does not permit the XSS 54 to determine the current status of a call. Therefore, CDRs may remain in the XSS 54 memory and require manual intervention to forcibly terminate a call and produce a CDR. A maximum call length parameter may be configured to perform this function automatically. If the length of a call exceeds this configured parameter, the call will be terminated by the XSS 52 and a CDR produced with an error code indicating the call condition.

The XDS is an efficient front end to a SQL database 56 that transfers the burden of SQL database 56 interfaces from the real-time VoIP management servers (XRE 54 and XSS 52). The XDS receives CDR and RDR information via sockets and either writes this data to a file or inserts the data into a SQL database 56. In one embodiment, MySQL is selected as the SQL database format. Other databases are used in other embodiments to contain and organize provisioning and other end user address relevant data.

In one embodiment, the invention relates to using a SIP Proxy Route Engine pair, a web server pair, and a provisioning database pair in conjunction with other telephony system components to facilitate a true peer-to-peer telephone call between end users. A SIP Proxy Route Engine pair refers to two systems redundantly configured to conduct SIP routing. A paired approach is used because it permits the ability to “load balance” or share hardware systems to reduce “single points of failure” and therefore increase overall system reliability. In one embodiment, this approach is implemented for each major component of the system and is especially important in the provision of “carrier class” functionality rather than “enterprise grade” where failures may be less catastrophic.

The route engine (XRE) 54 carries out many of the core real time operations of the VoIP telephony systems disclosed herein. Normally, only one XRE 54 is in use at a time. An additional XRE 54 may be defined and the pair may be used as peers in other embodiments. The pair configuration allows the inactive peer to resume the routing tasks for the VoIP network in case the active one is disabled. XSS is a protocol interface linked to the XRE. It processes SIP messages for call placement and registration and then translates the contents into the XRE language for entry into the XRE memory and for facilitating call placement.

The XRM 58 provides for offline configuration of registration and routing management and provides the capability to upload a configuration to the XRE in non-stop real-time mode. All provisioning data can be stored in the database 56. All changes to the provisioning database 56 can be tracked through an auditing process. The XRM provides a platform independent, Graphical User Interface (GUI), such as a Java-based GUI, to view and use the static configurations information that is available for use by the XRE. In one embodiment, this is accomplished in a non-service-affecting manner.

The Route Manager Client (Client) 60 provides a graphical user interface to the provisioning database 56. Route engines, gatekeepers, alternate gatekeepers, external access, internal devices, endpoints, hunt groups, route lists, routes, customers, associations and ANI lists can all be configured through the Client 60. The Client 60 provides real-time operational control of provisioning changes in the XREs 54. Using these operations, it is possible to test provisioning changes and write them to a startup file local to the XRE 54. This assures that the current provisioning data is available after a Route Engine 54 restart.

In various embodiments, the XRM, XRE, XDS, and XSS may be installed on a Microsoft Windows platform, a Linux platform, a Solaris platform, a Unix platform, and other operating systems as known in the art. However, each may be installed on individual machines as well in other embodiments.

FIG. 3B is a block diagram illustrating a system for routing VoIP traffic in a H.323 network, according to an embodiment of the invention. In this embodiment, a Gatekeeper Interface (XCI) 66 replaces the XSS in the previous embodiment illustrated by FIG. 3A. As shown, the XCI 66 receives routing information from a route engine 54′ in a manner similar to that discussed above with respect to FIG. 3A. However, instead of having end users, a number of gateways 70, 72, 74, 76 are connected to the H.323 network via Gateways Keepers 62, 66 here. Each Gateway Keeper 62, 66 may control one or more gateways 70, 72, 74, 76, and are managed by the XCI 66. The XCI 66 can be a Gatekeeper Transaction Message Protocol (GKTMP) compliant interface server that supports multiple simultaneous connections to gatekeepers 62, 64. The XCI 66 receives all RRQ, URQ, LRQ, LCF, ARQ and DRQ messages and sends Location ReQuest (LRQ) messages. In various embodiments, the XCI 66 may be setup on any Linux or Solaris system and can be configured to connect to one or more devices configured as a H.323 gatekeeper 62, 64.

The XCI 66 can be configured to write CDRs for each call that is referred to it for routing by a gatekeeper 62, 64. CDRs are produced for all call routing attempts, even those resulting in failure. CDRs may be written to a file or stored in the SQL database 56 via the XDS Server. When configured for file writing, CDRs are written to a local file named “cdr.cdf”, records in this file are comma-delimited format where each record is written in an ordered sequence of fields separated by commas and the record is terminated with a new-line character. The maximum size of this file is configurable. When the maximum size is reached, the file is renamed and a new file is created. Proper management of these CDR files is required to prevent system problems and loss of billable information.

Loss of DRQ and inability to receive IRR messages through the current release of GKTMP does not permit the XCI 66 to determine the current status of a call. Therefore, CDRs may remain in the XCI 66 memory and require manual intervention to forcibly write them to the CDR file. A maximum call length parameter may be configured to perform this function automatically. If the length of a call exceeds this configured parameter, the call will be terminated by the XCI 66 and a CDR produced with an error code indicating the call condition.

The XCI 66 supports five options for handling CDR records. The first option is that no CDR is recorded. This option is used when CDR information is collected through other means such as gateway records. This provides maximum performance for the XCI 66. The second option is that information from ARQs and DRQs will be recorded in a single CDR. The CDR is written when all expected DRQs are received. Due to missing DRQ messages, this method may leak CDRs. In this case the XCI 66 CLI command to force write a CDR is provided. The third option is that information from ARQs and DRQs will be recorded in a single CDR. The CDR is written when all the first DRQ is received. Due to missing DRQ messages, this method may leak CDRs. In this case the XCI 66 CLI command to force write a CDR is provided. Writing the CDR on the first received DRQ minimizes the CDR leak problem. The fourth option is that information from ARQs and DRQs will be recorded in separate CDRs, one for each ARQ or DRQ received. The CDR is written when the message is received. Multiple CDRs for each call must then be merged in a post-processing step to provide complete call details. There are no CDR leaks using this method. The fifth option is that information only from DRQs will be recorded in separate CDRs, one for each DRQ received. The CDR is written when the message is received. Multiple CDRs for each call may be merged in a post-processing step to provide complete call details. There are no CDR leaks using this method. This method is ideal when using the call detail information provided in a DRQ clear token.

The other components of the system, including the database 56′, the route engine 54′, the XRM 58′ and the Route Manager Client 60′ are similar to their counterparts described above in the embodiment illustrated by FIG. 3A.

In both embodiments illustrated by FIG. 3A and FIG. 3B, the systems support fail over redundancy at the XRE 54, 54′, XSS 52, XDS and XCI 66 levels. Redundant server installation is advised to assure maximal availability. Redundant XREs are provisioned from the same XRM, thus providing a single point of route provisioning. Provisioning is performed in an off-line environment using the XRM 54, 54′. Changes in provisioning data may be uploaded from the XRM 58, 58′ to the XRE 54, 54′ at any time. The XRE 54, 54′ always maintains two provisioning banks in memory, an on-line and an off-line bank. The on-line provisioning bank is used to provide routing for any route request received by the XRE 54, 54′. The off-line provisioning bank is used to accept new provisioning data and store previously on-line provisioning data while new provisioning data is being tested. Thus, new provisioning data may be uploaded to the XRE 54, 54′ without interfering with existing route request operations. This new data may be tested, and if testing is not successful, the previous on-line provisioning data may be brought back on-line. These operations are instantaneous when a control message is received. An XRM Client application can be used to control these provisioning operations.

In addition to the in memory provisioning banks, the XRE 54, 54′ maintains a disk file based provisioning bank that is loaded upon XRE 54, 54′ startup. This provides for fast startup and initial configuration in the event of application or system failures. The XRM Client can be a Java application and may execute from any environment supporting the Java Runtime Environment (JRE). It connects to the XRM via a socket connection and thus must have IP connectivity with the XRM 58, 58′. In one embodiment, all socket connections in the server family are secure, all transmitted data is encrypted.

The XCI 66, XSS 52 and XRE 54, 54′ servers maintain statistics on message processing and can display this information in a remote telnet-compliant terminal. This data includes counts of request messages, response statistics, error counts, current registration state of provisioned resources, and trace logging control. Trace logging in the XRE 54, 54′ can be configured to have low performance impact and focused on test calls or resources. Tracing can be triggered based on ANI, DNIS, route, gatekeeper, endpoint, hunt group, or customer involved in a call. This provides for effective real-time tracing without impacting normal operations.

The XRE 54, 54′ optionally produces Route Detail Records (RDR) for each route request it handles. This permits an accounting based on route operations performed for off-net partners and can provide a view of the routing processing characteristics of the VoIP network. The XCI 66 and XSS 52 optionally produce CDRs for each call it handles. These records can be used to permit accounting based on call transactions.

As illustrated in previous diagrams and charts, the XRE is a system component integrated singly or in a paired fashion in a number of embodiments of the present invention. The components of the XRE include software that is designed to manage routes, and includes algorithms that are specific to managing the VoIP processes. The components of XRE are designed to facilitate a small software and hardware “footprint” thus allowing for improved economical scalability. The ability to encompass the set of functionality indicated below on relatively inexpensive 2.8 GHz computer platforms is in itself unique. Thus, consumer grade and legacy processors can be used in personal computers to server as the non-carrier server with an installed route engine.

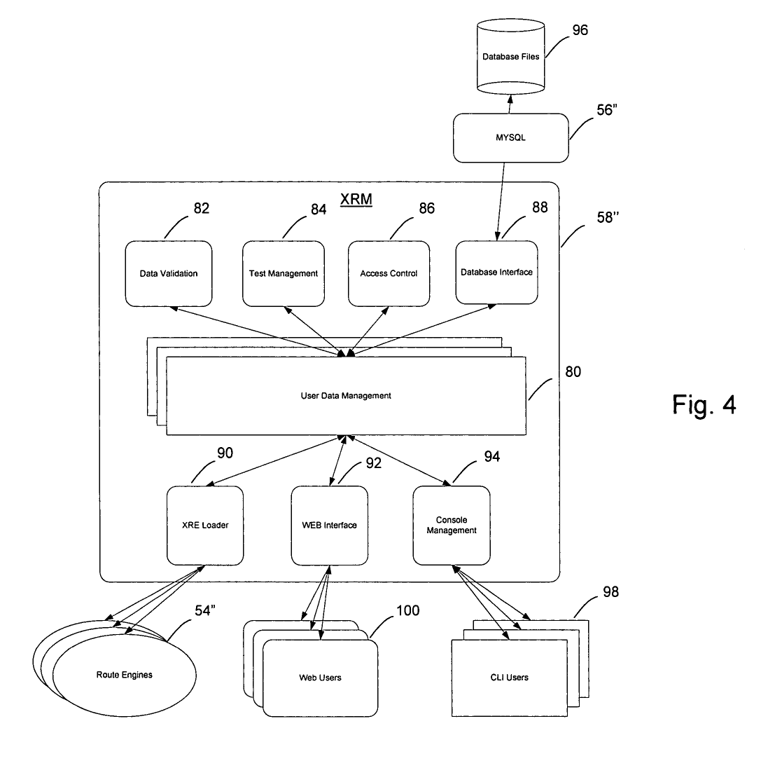

FIG. 4 is a detailed block diagram of the XRM 58″ architecture according to another embodiment of the invention. The XRM 58″ includes a number of user data managements components, a data validation component 82, a test management component 84, an access control component 86, a database interface 88, a XRE route engine loader 90, a web interface 92, and a console management component 94. The role of the XRM 58″ is to facilitate proper call routing to desired destinations in a prompt and efficient manner. The components of an exemplary XRM embodiment, their functions, and relationships are described as follows. These components can be implemented as a combination of software modules as known to one of ordinary skill in the art. The database is a permanent store of all information relevant to each user as well as containing information on specific routes. The access control element contains the definitions for external and internal devices that are to be used within the system. The test management element provides a vehicle for the testing of prospective routes. The data validation element works in conjunction with web users to ensure consistency of their data input. The console management element can be a command line utility. The web interface element can be a Java GUI. The XRE Loader is an interface to the route engine controlling which data bank is to be used at a given time.

In one embodiment, the system uses a TRIE algorithm (derived from “reTRIEval”) and other related algorithms to facilitate calls between users. In particular, this algorithm facilitates searching the provisioning database to quickly locate any device or third party addresses. A trie, or prefix tree, is an ordered tree data structure that is used to store an associative array where the keys are strings. Unlike a binary search tree, no node in the tree stores the key associated with that node; instead, its position in the tree shows the associations to other keys for that particular key. All the descendants of any one node have a common prefix of the string associated with that node, and the root is associated with the empty string. When searching a trie, the system conducts the search in a reverse manner rather than in the more commonly used linear fashion. This facilitates the choice of the longest matching string first. The more specific information contained within the string, the better the routing choice as compared to the use of wild card selections.

In addition, existing algorithms can be used for load balancing and association matching. The load balancing algorithms use resource availability factors for a specific device such as a gateway. The algorithm determines the degree to which a specific device is being used, whether or not it is ready to accept additional calls, and the placement of the call. Resource management can be maintained on an automated basis or can be managed manually for the implementation of maintenance windows and “fail over” states initiated by external stimuli. An additional related algorithm implements a “shifting range of priorities” whereby the system is constantly shifting back and forth between devices based on changing resource loading factors.

Association matching algorithms are used for two different areas—internal associations that determine how the elements interact with themselves and other available elements, and paired associations that are fixed rather than variable. The internal association matching algorithm has three different characteristics: member to member, member to non-associative member, and non-associative member to member. This algorithm defines the default relationships within the association and population in general. Paired associations explicitly define the relationship between two elements: A calls B or B calls A. These characteristics can be one-way or two-way. These algorithms can be implemented using various languages and coding schemes as known to one of ordinary skill in the art.

Additional Distributed Telephony System Features and Enhancements

The embodiments of the route engine and the other system components described herein provide many features suitable for implementing a reliable large scale VoIP deployment. In general, the telephony system embodiments, methods, and apparatus disclosed herein can include various enhanced features that offer improvements to end users that have been unavailable in traditional phone systems. These features include:

E.164 dialed number plans—Any E.164 compliant number may be used for routing. E.164 compliant numbers are comprised of a country code, optional area code, and subscriber number. Lengths of E.164 numbers may be up to 35 digits.

Custom dialed number plan—A custom dialed number is a shorthand number used to quickly reach a phone associated with a customer definition. This feature is typically used to implement 3 or 4 digit numbers for each phone in an actual or virtual office.

Dialed number translation—Translations of the dialed string permit the redirection of a dialed number to reach a destination.

Extended dialing area recognition (10 digit dialing)—Permits dropping the national dial prefix from a dialed number string.

Local dialing area recognition (7 digit dialing)—Used in some local areas, this permits dropping the national dial prefix and area code from a dialed number string.

Dialed number blocking—Dialed numbers may be blocked for all uses or specific customers. Blocked numbers prevent calls to numbers from completing. Blocked routes can be global, associated to a customer, a gatekeeper, an endpoint, or a hunt group. All call sources identified by the blocked number will fail to complete a call to a matched blocked route.

Destination excluded routes—Excluded routes prevent a dialed number from completing a call to a specified destination. This feature can be used to simplify route provisioning, since one or more excluded ranges may be used in additional to other wide ranged routes that include the excluded routes.

Prioritized routing—Supported routes can be ranked using a priority value. Lower priority values are selected before higher values. Priorities may be used to provide redundant routing with lower priority routes selected as backup routes in case higher value routes fail or their associated destination devices are unavailable. Route priorities may also be used to implement a least cost routing capability, the lower the cost the lower a priority may be set causing it to be selected before higher cost routes. Priority values can range from 1 to about 65535, inclusive.

Dialed number range specification—Routes may be specified to match ranges of dialed numbers. Ranges are typically provisioned with a start range digit pattern and an end range digit pattern of the same length. For example, the range 1212234-1212236 is a valid range; however, the 122234-1213 is not a valid range. An empty route may also be provisioned; this indicates a match for all dialed numbers.

Dialed number length matching—All route types may have their minimum and maximum matching lengths specified. Only routes that match both the dialed number pattern as well as the length restrictions are matched.

Switch style routing—Routes without length restrictions are matched solely on the specified dialed number pattern. This provides routing similar to traditional telecommunications switches.

Dedicated routes for on-net IP devices—A dedicated route can be used when an E.164 number is assigned to an on-net IP device. If the dial string matches a dedicated route, only that route will be used to forward the call to the destination. Alternate routes will not be used. Unlike other E.164 numbers, no other path can exist to provide a connection to that E.164 device. Dedicated routes take affect even if the device is off-line. Dedicated routes should only be used when: The IP device registers only to a local gatekeeper; or there is no other device associated with the E.164 number.

Time of day route control—Time of day control can be applied to routes. This permits time based availability rules to be used for route management to optimize route cost changes on a daily or weekly basis.

Sourced based routing—Sourced based routing are routes that are associated with an identifiable customer. This feature provides for custom routing for services such as high quality or lowest cost. Customers may be identified with gatekeepers, endpoints, hunt groups or by ANI.

Redundant routes—Multiple routes can be returned to source endpoint to provide redundancy in IP network paths to assure high call completion rates. Up to 10 routes may be returned.

Best match route selection—Routes that are provisioned with the same priority are selected in order of best match. Thus, routes that match more dialed digits are selected first. This provides for fine-tuning routes that have overlapping ranges so that, if available, destination devices with a more granular matching route will be selected.

Remote device validation—Off-net devices that attempt to send calls or route requests to the on-net system may be validated based on IP address. This provides a level of security for off-net originating traffic.

Time of day device control—Time of day control can be applied to devices (gatekeepers, endpoints or hunt groups). This permits time based availability rules to be used for device management to optimize route cost changes on a daily or weekly basis.

Alternate gatekeeper lists for endpoint registration—Provides for list management of on-net gatekeepers for fail over at the endpoint level. Used to increase system availability when gatekeepers fail or are placed in maintenance mode.

Resource management—Resource management may be performed by the XRE 58″ without usage of RAI messages. The XCI and XRE 58″ can be used in tandem to keep track of usage rates for provisioned devices. This can provide effective management of VoIP traffic and assure better call completion rates. Devices may be resource controlled using threshold benchmarks or bandwidth quantities. In the event that both RAI and XRE 58″ resource management are used, the method that triggers first will control the device availability.

Inbound traffic throttling—Acceptance of off-net to on-net traffic can be controlled to assure availability for on-net or preferred off-net traffic. Off-net sources can be throttled based on maximum simultaneous calls, call minutes per day, or call count per day. Once the throttle criterion has been exceeded, additional call requests are rejected. This provides a convenient mechanism to prevent off-net flooding of on-net resources.

Load balancing—When multiple routes with the same priority are selected, optional load balancing among their associated destinations can be performed. Routes associated with the least loaded devices can be selected first.

Network partitioning—Multiple partitions may be created using associations. Each association contains a list of devices. Calls to and from members of an association are subject to rules. These rules permit: association members to call members of other associations; association members to be called by members of other associations; association members to call.

Transaction based trace logging—Transaction based logging is controlled using the Command Line Interface (CLI) available on default port 11000. Connecting to this port with a terminal utility provides a set of commands to view statistical data and control tracing. ANI, DNIS, route, gatekeeper, endpoint, hunt group, or customer may trigger route transaction tracing to a log file.

Route detail records—The XRE 58″ can be configured to write Route Detail Records (RDRs) for each route request received from a XCI. RDRs are produced for all route attempts, even those resulting in failure. RDRs are written to a local file named “rdr.cdf”, records in this file are comma-delimited format where each record is written in an ordered sequence of fields separated by commas and the record is terminated with a new-line character. The maximum size of this file is configurable, when reached, the file is renamed and a new file is created. Proper management of these RDR files helps prevent system problems and loss of billable information.

The methods and systems described herein can be performed in software on general purpose computers, servers, or other processors, with appropriate magnetic, optical or other storage that is part of the computer or server or connected thereto, such as with a bus. The processes can also be carried out in whole or in part in a combination of hardware and software, such as with application specific integrated circuits. The software can be stored in one or more computers, servers, or other appropriate devices, and can also be kept on a removable storage media, such as a magnetic or optical disks. Furthermore, the engines, managers, modules, and other apparatus and methods described herein can be implemented using as a Software Development Kit (SDK), an API, as middleware, and combinations thereof.

It should be appreciated that various embodiments of the claimed invention are directed to subsets and substeps of the techniques disclosed herein. Further, the terms and expressions employed herein are used as terms of description and not of limitation, and there is no intention, in the use of such terms and expressions, of excluding any equivalents of the features shown and described or portions thereof, but it is recognized that various modifications are possible within the scope of the embodiments of the invention claimed. Accordingly, what is desired to be secured by Letters Patent is the embodiments of the invention as defined and differentiated in the following claims, including all equivalents.

1. A telephony system comprising
a server adapted to interface with a client application which is adapted to interface with a first communication device,
the server comprising a route engine, a web server interface, and a registration module, wherein the route engine is adapted to exchange provisioning data with the client application and initiate a VoIP communication route between the first communication device and a second communication device in response to the provisioning data, the second communication device adapted to exchange voice over internet protocol (VoIP) data with the first communication device.

2. The telephony system of claim 1 wherein the server is configured such that data transmitted through the VoIP communication route is isolated from the server.

3. The telephony system of claim 1 wherein the route engine is adapted to accommodate at least 8,000 route requests per second.

4. The telephony system of claim 1 wherein registration module is a Session Initiated Protocol (SIP) registration and redirection server module.

5. The telephony system of claim 1 wherein the provisioning data includes an address associated with the second communication device.

6. The server of claim 1 further comprising a route manager in electronic communication with the route engine and a provisioning database.

7. A telephony system adapted for initiating VoIP data exchange between a plurality of end users, the system comprising
a server adapted to interface with a client application adapted to interface with at least one communication device, the communication device associated with one of the plurality of end users, and
a provisioning database comprising end user address data, the server further adapted to initiate a VoIP communication channel between two of the plurality of end users using a portion of a public network, the server comprising a route engine, wherein the route engine establishes the VoIP communication channel in response to a query of the end user address data.

8. The system of claim 7 wherein the VoIP communication channel comprises at least one data route through a portion of the internet such that the data route does not pass through the server.

9. The telephony system of claim 7 wherein the client application is associated with a user agent.

10. The telephony system of claim 9 wherein the user agent is selected from the group consisting of a communication device, a soft phone, an IP phone, and a software client.

11. The telephony system of claim 7 wherein the server is a personal computer having a consumer grade processor that has an operating frequency that ranges from about 1 GHz to about 4 GHz.

12. The telephony system of claim 7 wherein the VoIP communication channel is adapted to transmit data selected from the group consisting of voice data, video data, audio data, image data, files, and text.

13. A method of establishing a carrier server independent VoIP communication channel between a first end user and a second end user, the method comprising the steps of
receiving a first data exchange from a client application associated with the first end user;
determining an availability status and an IP address associated with the second end user using a provisioning database in response to the first data exchange;
establishing a VoIP communication channel between the first and second end users in response to the availability status using a route engine; and
isolating the first and second end users from the non-carrier server once the VoIP communication channel is active such that VoIP data is not exchanged between the end users and a non-carrier server.

14. The method of claim 13 wherein the VoIP communication channel comprises at least one data route through a portion of the internet such that the data route does not pass through the non-carrier server.

15. The method of claim 13 wherein the VoIP communication channel comprises at least one data route through a portion of the internet such that the data route does not pass through the server.

16. A method of enhancing data security of information transmitted using a VoIP telephony system, the method comprising the steps of
collecting end user account and registration information for a VoIP telephony service;
providing a client application associated with a user agent for use with the VoIP telephony service;
registering an availability status of each end user in response to activation of the user agent;
identifying the destination IP address for a called end user in response to a phone call attempt by a calling end user using a route engine resident on a non-carrier server associated with the VoIP telephony service;
forming a VoIP communication channel between the calling end user and the called end user such that any voice data exchanged between the calling and called end users is not routed through the non-carrier server.

17. The method of claim 16 wherein the VoIP communication channel comprises at least one data route through a portion of the internet such that the data route does not pass through the non-carrier server.

18. The method of claim 16 further comprising the steps of authenticating the end users for billing purposes.

19. A route manager adapted for managing a route engine and a carrier server independent VoIP communication channel, the route manager comprising
a database, the database comprising provisioning data;
an access control element, the access control element comprising interface definitions relating to communication devices suitable for forming the VoIP communication channel; and
a route engine loader adapted to interface with the route engine and access the database to determine which provisioning data is being accessed.

20. The route manager of claim 19 further comprising a test management element in electronic communication with the database, the test management element adapted for testing of prospective routes using provisioning data.

21. The route manager of claim 20 further comprising a data validation element in electronic communication with the route engine, the data validation element adapted to enhance consistency of data transmission through the carrier server independent VoIP communication channel.
